(19) United States
(12) Patent Application Publication
(10) Pub. No.: US 2004/0258116 A1
(43) Pub. Date: Dec. 23, 2004

(54) Laser diode driving circuit

(75) Inventors: Young-ju Kim, Suwon-si (KR); Pyong-yong Seong, Seoul (KR); Chul-ho Jeon, Suwon-si (KR); Jong-ryull Kim, Siheung-si (KR); Kyoung-hwan Park, Suwon-si (KR); Jun-hyuk Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/694,395

(22) Filed: Oct. 28, 2003

(30) Foreign Application Priority Data
Oct. 29, 2002 (KR) 2002-66127

(51) Int. Cl. H01S 3/00; H01S 3/04

(52) U.S. Cl. 372/38.02; 372/38.07; 372/38.09; 372/34

(57) ABSTRACT

Provided is a laser diode driving circuit which prevents low optical output power of a laser diode at high ambient temperature, and prevents damage to the laser diode at low ambient temperature by adjusting the limit of a laser diode driving current, which is input to a laser diode, based on an optical output power characteristic that decreases optical output power as the ambient temperature decreases. Such a laser diode driving circuit includes a laser diode driving unit, which outputs a laser diode driving current and a laser diode protection unit, which sets the limit of the laser diode driving current output from the laser diode driving unit and increases the limit of the laser diode driving current as the ambient temperature of the laser diode increases.

### CROSS-REFERENCE TO RELATED APPLICATIONS

This application claims the priority of Korean Patent Application No. 2002-66127, filed on 29 Oct. 2002 in the Korean Intellectual Property Office, the disclosure of which is hereby incorporated by reference in its entirety.

### BACKGROUND OF THE INVENTION

1. Field of the Invention

The present invention relates to a laser diode driving circuit, and more particularly, to the laser diode driving circuit having a laser diode protection unit that adjusts the limit of a laser diode driving current, which is input to a laser diode, based on the ambient temperature.

2. Description of the Related Art

In general, contactless optical devices, such as CD-ROM and DVD-ROM drives, project light onto a disk by using a laser diode (LD), convert the light reflected off the disk into an electrical signal by using a photo diode (PD), and read data recorded on the disk by processing the electrical signal.

The LD receives a laser diode driving current and outputs optical power with respect to the amount of LD driving current. The optical output power is reflected off the disk and then partially input to the PD. The optical output power used as input to the PD needs to be maintained at a specific level for subsequent signal processing of the optical devices.

The optical output power changes with respect to the ambient temperature or aging of the LD. In other words, the LD driving current required for outputting the optical output power at a specific level changes with respect to the ambient temperature or aging of the LD. To maintain the optical output power, which is input to the PD, at a specific level, it is necessary to adjust the LD driving current based on the level of optical output power. In addition, when an excessive amount of optical output power is output because of an excessive amount of LD driving current input to the LD, the optical power cannot be managed appropriately by the LD and possible damage to the LD may occur.

FIG. 1 illustrates a conventional laser diode (LD) control device that controls the optical output power of the LD. As shown in FIG. 1, the LD control device typically includes an automatic laser power control (ALPC) circuit 100 and a laser diode (LD) driving circuit 102. The ALPC circuit 100 receives an output signal of the PD 103, sets a reference voltage based on the change of the magnitude of the output signal, and outputs the reference voltage. The LD driving circuit 102 outputs the LD driving current to the LD 101, driving the LD 101 based on the reference voltage. The LD driving circuit 102 includes a laser diode (LD) driving unit 102a and a laser diode (LD) protection unit 102b. The LD driving unit 102a outputs the LD driving current to the LD 101. The LD protection unit 102b prevents output of excessive optical output power which may cause damage to the LD 101.

The LD driving circuit 102 has nodes represented by reference numerals (1) through (5). Node (1) is connected to the ALPC circuit 100 and node (5) is connected to the LD 101. A bias point resistance R₁ is disposed between node (1) and node (2). The collector of a second transistor Q₂, which functions as an on/off switch for a first transistor Q₁, is connected to node (2). The emitter of the second transistor Q₂ is connected to node (3), which is connected to a voltage V_{CC}. A resistor R₂ is disposed between node (3) and node (4), and determines the amount of on/off switching current of the second transistor Q₂. The base of the second transistor Q₂ is connected to node (4). The base of the first transistor Q₁ is connected to node (2), while the emitter is connected to node (4), and the collector is connected to node (5). The first transistor Q₁ functions as an emitter follower amplifier. A capacitor C, used for noise removal is disposed between node (2) and node (3). A capacitor C₂ is disposed between node (5) and a ground terminal, and is used to remove noise and smooth the LD driving current by preventing any sudden changes in the LD driving current. PD 103 in FIG. 1 represents a photo diode.

Hereinafter, the operation of the LD driving circuit 102 will be described.

The voltage between the emitter and the base of the second transistor Q₂ is equal to the resistance of the resistor R₂ multiplied by the current flowing through the resistor R₂, in accordance with Ohm's law. To turn on the second transistor Q₂, a voltage of 0.5-0.7 V must be applied between the emitter and the base of the second transistor Q₂, (i.e., between node (3) and node (4)). Since the resistance of the resistor R₂ hardly changes with respect to the ambient temperature, the current flowing through the resistor R₂ determines on/off states of the second transistor Q₂. In other words, the current that turns on the second transistor Q₂ (i.e., an on-state current of the second transistor Q₂,) remains substantially constant with respect to the ambient temperature.

When the current flowing through the resistor R₂ reaches the level of the on-state current of the second transistor Q₂, the second transistor Q₂ is turned on and a current flows from the voltage V_{CC} through the second transistor Q₂. In this case, the voltage at node (2) (i.e., the voltage at the base of the first transistor Q₁,) is higher than the voltage at the emitter of the first transistor Q₁ As a result, the first transistor Q, is turned off, and the LD driving current no longer flows to the LD 101.

On the other hand, when the current flowing through the resistor R₂ is smaller than the on-state current of the second transistor Q₂, the second transistor Q₂ is turned off. In this case, it may be assumed that the second transistor Q₂ does not exist in the LD driving circuit 102. The first transistor Q₁, which is turned on, outputs the LD driving current to its collector. The current at the collector of the first transistor Q₁, i.e., the LD driving current, is changed with respect to the reference voltage output from the ALPC circuit 100.

Because the current at the base of the first transistor Q, is much smaller than the current at the emitter of the first transistor Q₁, the current at the collector of the first transistor Q₁ (i.e., the LD driving current,) is similar to the current at the emitter of the first transistor Q₁ Because the current at the emitter of the first transistor Q₁ also cannot be greater than the on-state current of the second transistor Q₂, the LD driving current cannot be greater than the on-state current of the second transistor Q₂. Therefore, the resistance of the resistor R₂ determines the limit of the LD driving current. As such, the LD driving current of the conventional LD driving circuit is determined as a specific value by the resistance of the resistor R₂.

However, the conventional LD driving circuit 102 does not take into account that the optical output power characteristic of the LD 101 changes with respect to the ambient temperature.

FIG. 2 is a graph showing the relationship between the LD driving current and the optical output power with respect to an ambient temperature parameter, in which the horizontal axis represents the LD driving current and the vertical axis represents the optical output power of the LD 101. As shown in FIG. 2, as the ambient temperature increases, the optical output power of the LD 101 decreases. In other words, the LD driving current must increase with an increase in the ambient temperature so that the LD 101 can maintain optical output power at a specific level. Because the LD protection unit 102b, including the resistor R₂ and the second transistor Q₂, maintains the voltage between node (3) and node (4) at 0.5-0.7 V independent of the ambient temperature, and the resistance of the resistor R₂ increases slightly with an increase in the ambient temperature, the limit of the LD driving current will decrease slighlty with an increase in the ambient temperature.

In short, when the ambient temperature is higher, more LD driving current must be provided to the LD 101, so that the LD 101 can output the optical output power at a specific level. However, the LD protection unit 102b decreases the limit of the LD driving current as the ambient temperature increases. As a result, when the resistance of the resistor R₂ is determined by focusing on the prevention of damage to the LD 101 at a low ambient temperature, low optical output power is inevitable at a high ambient temperature. On the other hand, when the resistance of the resistor R₂ is determined by focusing on providing sufficient LD driving current and preventing the LD 101 from outputting low optical output power, the limit of the LD driving current becomes excessively great at a low ambient temperature, which may cause damage to the LD 101.

### SUMMARY OF THE INVENTION

The present invention provides a laser diode (LD) driving circuit that enables a laser diode (LD) to maintain maximum optical output power at a specific level independent of changes in ambient temperature.

The present invention also provides a laser diode (LD) driving circuit that is capable of preventing damage to a laser diode (LD) due to excessive optical output power at low ambient temperature.

The present invention also provides a laser diode (LD) driving circuit that is capable of preventing a laser diode (LD) from outputting low optical output power at high ambient temperature.

Additional aspects and/or advantages of the invention will be set forth in part in the description which follows and, in part, will be obvious from the description, or may be learned by practice of the invention.

According to an aspect of the present invention, there is provided a laser diode driving circuit comprising a laser diode driving unit and a laser diode protection unit. The laser diode driving unit outputs a laser diode driving current. The laser diode protection unit sets a limit of the laser diode driving current output from the laser diode driving unit and increases the limit of the laser diode driving current as ambient temperature of the laser diode increases.

According to another aspect of the present invention, there is provided a laser diode driving circuit comprising a first transistor, a second transistor, and a thermistor. The first transistor outputs a laser diode driving current. The second transistor is turned on and turns off the first transistor when a current flowing through a node of the first transistor reaches a predetermined value, the node excluding a node through which the first transistor outputs the laser diode driving current and a node through which the first transistor receives a reference signal. The thermistor with a negative temperature coefficient sets the current that turns on the second transistor and increases the current as the ambient temperature of a laser diode increases.

### BRIEF DESCRIPTION OF THE DRAWINGS

These and/or other aspects and advantages of the invention will become apparent and more readily appreciated from the following description of the exemplary embodiments, taken in conjunction with the accompanying drawings of which:

FIG. 1 illustrates a conventional laser diode (LD) control device that controls the optical output power of a laser diode (LD);

FIG. 2 is a graph showing the conventional relationship between a laser diode (LD) driving current and optical output power with respect to an ambient temperature parameter;

FIG. 3 is a circuit diagram of a laser diode (LD) control device including a laser diode (LD) driving circuit, according to the present invention; and

FIG. 4 is a graph showing the relationship between resistance and ambient temperature in the thermistor of FIG. 3.

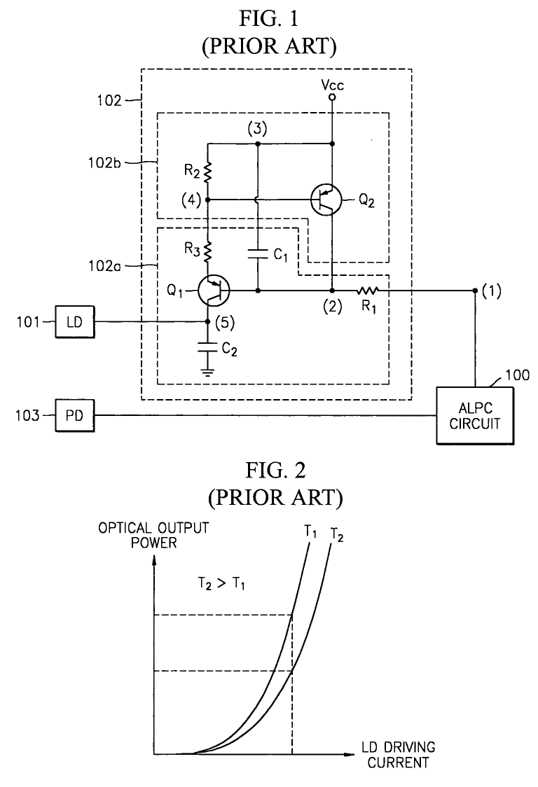

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

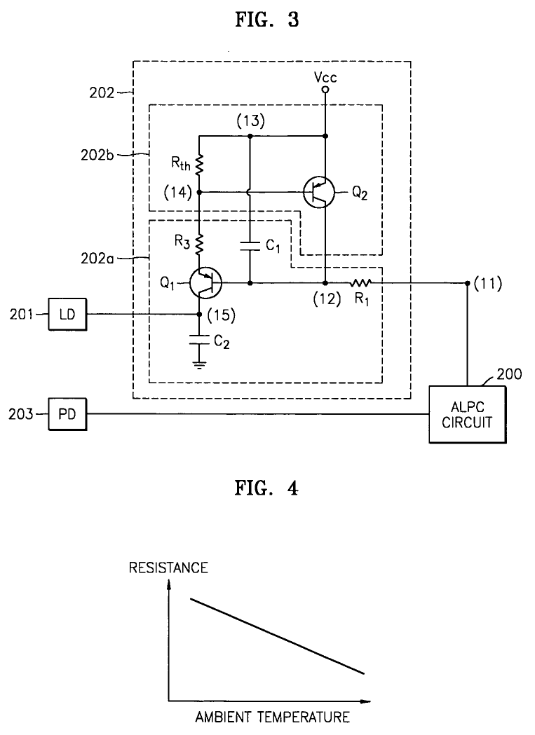

FIG. 3 is a circuit diagram of a laser diode (LD) control device including a laser diode (LD) driving circuit, according to the present invention. As shown in FIG. 3, the LD control device according to an embodiment of the present invention includes an automatic laser power control (ALPC) circuit 200 and an LD driving circuit 202. The ALPC circuit 200 receives the output signal of a photo diode (PD) 203, sets a reference voltage based on the change of the magnitude of the output signal, and outputs the reference voltage. The LD driving circuit 202 outputs an LD driving current to the LD 201, based on the reference voltage. The LD driving circuit 202 includes an LD driving unit 202a and an LD protection unit 202b. The LD driving unit 202a outputs the LD driving current to the LD 201. The LD protection unit 202b prevents the LD 201 from outputting an excessive amount of optical output power to the LD 201 and potentially causing damage to the LD 201.

The LD driving circuit 202 has nodes represented by reference numerals (11) through (15). Node (11) is connected to the ALPC circuit 200 and node (15) is connected to the LD 201. A bias point resistance R₁ is disposed between node (11) and node (12). The collector of a second transistor Q₂, which functions as an on/off switch of a first transistor Q₁, is connected to node (12). The emitter of the second transistor Q₂ is connected to node (13), which is connected to a voltage V_{CC}. A thermistor Rₜₕ having a negative temperature coefficient is disposed between node (13) and node (14) and determines the level of on/off switching current that actuates the second transistor Q₂. The base of the second transistor Q₂ is connected to node (14). The base of the first transistor Q₁ is connected to node (12), while the emitter is connected to node (14), and the collector is connected to node (15). The first transistor Q₁ functions as an emitter follower amplifier. A capacitor C₁ used for noise removal is disposed between node (12) and the node (13). A capacitor C₂ is disposed between node (15) and a ground terminal, and is used to remove noise and smooth the LD driving current by preventing any sudden changes in the LD driving current. PD 203 in FIG. 3 represents a photo diode.

Hereinafter, the operation of the LD driving circuit 202 will be described.

The voltage between the emitter and the base of the second transistor Q₂ is equal to the resistance of the resistor Rₜₕ multiplied by the current flowing through the resistor Rₜₕ, in accordance with Ohm's law. To turn on the second transistor Q₂, a voltage of 0.5-0.7 V must be applied between the emitter and the base of the second transistor Q₂ (i.e., between the node (13) and the node (14)). In other words, the second transistor Q₂ is turned on or off in relation to the voltage between the two ends of thermistor Rₜₕ (i.e., node (13) and node (14)). The thermistor Rₜₕ has a negative temperature coefficient (NTC). As shown in FIG. 4, the thermistor Rₜₕ exhibits a decrease in electrical resistance with increasing temperature. Consequently, when the ambient temperature increases, a greater amount of current is needed to maintain the voltage between the emitter and the base of the second transistor Q₂ at 0.5-0.7 V and to turn on the second transistor Q₂. In other words, the current that turns on the second transistor Q₂ (i.e., an on-state current of the second transistor Q₂) increases with respect to an increase in ambient temperature.

When the current flowing through the thermistor Rₜₕ reaches the level of the on-state current of the second transistor Q₂, the second transistor Q₂ is turned on and a current flows from a voltage V_{CC} through the second transistor Q₂. In this case, the voltage at node (12) (i.e., the voltage at the base of the first transistor Q₁) is higher than the voltage at the emitter of the first transistor Q₁ As a result, the first transistor Q₁ is turned off, and the LD driving current no longer flows to the LD 201.

On the other hand, when the current flowing through the thermistor Rₜₕ is smaller than the on-state current of the second transistor Q₂, the second transistor Q₂ is turned off. In this case, it may be assumed that the second transistor Q₂ does not exist in the LD driving circuit 202. The first transistor Q₁, which is turned on, outputs the LD driving current to its collector. The current at the collector of the first transistor Q₁ (i.e. the LD driving current) is changed with respect to the reference voltage output from the ALPC circuit 200.

Because the current at the base of the first transistor Q₁ is much smaller than the current at the emitter of the first transistor Q₁, the current at the collector of the first transistor Q₁ (i.e. the LD driving current) is similar to the current at the emitter of the first transistor Q₁ Since the first transistor Q₁ is turned off when the current flowing through the thermistor Rₜₕ reaches the level of the on-state current of the second transistor Q₂, and the LD driving current does not flow to the LD 201, the limit of the LD driving current flowing through the thermistor Rₜₕ is equal to the on-state current of the second transistor Q₂. Consequently, the thermistor Rₜₕ determines the limit of the LD driving current. Since the limit of the LD driving circuit delimits the maximum optical output power of the LD 201, the thermistor Rₜₕ determines the maximum optical output power of the LD 201.

In an aspect of the present invention, the NTC thermistor Rₜₕ determines the limit of the LD driving current. The thermistor Rₜₕ and the second transistor Q₂ constitute the LD protection unit 202b, which prevents the flow of excessive LD driving current to the LD 201.

While not required in all aspects of the invention, the thermistor Rₜₕ preferably has a negative temperature coefficient that enables the LD 201 to maintain maximum optical output power at a specific level by compensating for characteristic fluctuations of the optical output power due to changes in ambient temperature. The specific values may be chosen to tailor the circuit to specific applications.

As described above, the LD driving circuit according to the present invention changes the limit of the LD driving current provided to the LD with respect to changes in the ambient temperature and maintains the maximum optical output power of the LD at a specific level. Thus, it is possible to prevent the LD from outputting low optical output power at high ambient temperatures and prevent damage to the LD due to excessive optical output power at low ambient temperatures.

While the present invention has been particularly shown and described with reference to exemplary embodiments thereof, it will be understood by those of ordinary skill in the art that various changes in form and details may be made therein without departing from the spirit and scope of the invention as defined by the accompanying claims and their equivalents.

What is claimed is:

1. A laser diode driving circuit comprising:
a laser diode driving unit which outputs a laser diode driving current; and
a laser diode protection unit which sets a limit of the laser diode driving current output from the laser diode driving unit and increases the limit of the laser diode driving current as an ambient temperature of a laser diode increases.

2. The laser diode driving circuit of claim 1, wherein the laser diode protection unit includes a thermistor, coupled to an emitter and a base of a first transistor, that limits the maximum driving current output by the laser diode driving unit.

3. The laser diode driving circuit of claim 2, wherein the laser diode driving unit includes a second transistor that outputs a driving current to the laser diode when the second transistor is turned on.

4. The laser diode driving circuit of claim 3, wherein a collector of the first transistor is coupled to a base of the second transistor and operates to turn off the second transistor when the first transistor is on.

5. The laser diode driving circuit of claim 2, wherein the thermistor has a negative temperature coefficient so as to have a decreasing resistance as the ambient temperature increases.

6. A laser diode driving circuit comprising:
a first transistor which outputs a laser diode driving current;
a second transistor which is turned on and turns off the first transistor when a current flowing through a node of the first transistor reaches a predetermined value, the node being other than a node through which the first transistor outputs the laser diode driving current and a node through which the first transistor receives a reference signal; and
a thermistor with a negative temperature coefficient which sets the current that turns on the second transistor and increases the current as the ambient temperature of a laser diode increases.

7. The laser diode driving circuit of claim 6, wherein the thermistor has such a negative temperature coefficient that the current which turns on the second transistor changes as the ambient temperature of the laser diode changes, so that a maximum optical output power of the laser diode is maintained at a specific level independent of the ambient temperature of the laser diode.

8. A current limited laser diode driving circuit comprising:
a laser diode;
means for controlling an application of a driving current to the laser diode;
means for limiting the driving current output from the controlling means so as to increase a limit of the driving current as an ambient temperature of the laser diode increases.

9. The current limited diode driving circuit of claim 8, wherein the limiting means includes a thermistor responsive to ambient temperature that sets the operating current of a second transistor.

10. The current limited diode driving circuit of claim 9, wherein the controlling means includes a first transistor responsive to a second transistor that outputs a driving current to the laser diode when the first transistor is turned on.

11. The current limited diode driving circuit of claim 9, wherein the thermistor has a negative temperature coefficient so as to have a decreasing resistance as the ambient temperature increases.

12. A method for limiting the driving current applied to a laser diode comprising:
passing a current through a thermistor to provide an adjustable current;
if the adjustable current flowing through the thermistor is below a predetermined threshold, then providing the current to the laser diode through a first transistor;
if the adjustable current flowing through the thermistor is above the predetermined threshold, then using a second transistor to turn off the first transistor to prevent the current from reaching the laser diode.
